(19) United States
(12) Patent Application Publication
(10) Pub. No.: US 2014/0032323 A1
(43) Pub. Date: Jan. 30, 2014

(54) System is described for providing targeted business messages (announcement, promotion, etc.) to potential customers near the business location

(71) Applicant: Sanjaykumar Harish Joshi, Brambleton, VA (US)

(72) Inventor: Sanjaykumar Harish Joshi, Brambleton, VA (US)

(21) Appl. No.: 13/561,147

(22) Filed: Jul. 30, 2012

(51) Int. Cl. G06Q 30/02

(52) U.S. Cl. 705/14.58

(57) ABSTRACT

A system is described for providing targeted business messages (announcement, promotion, etc.) to potential customers near the business location

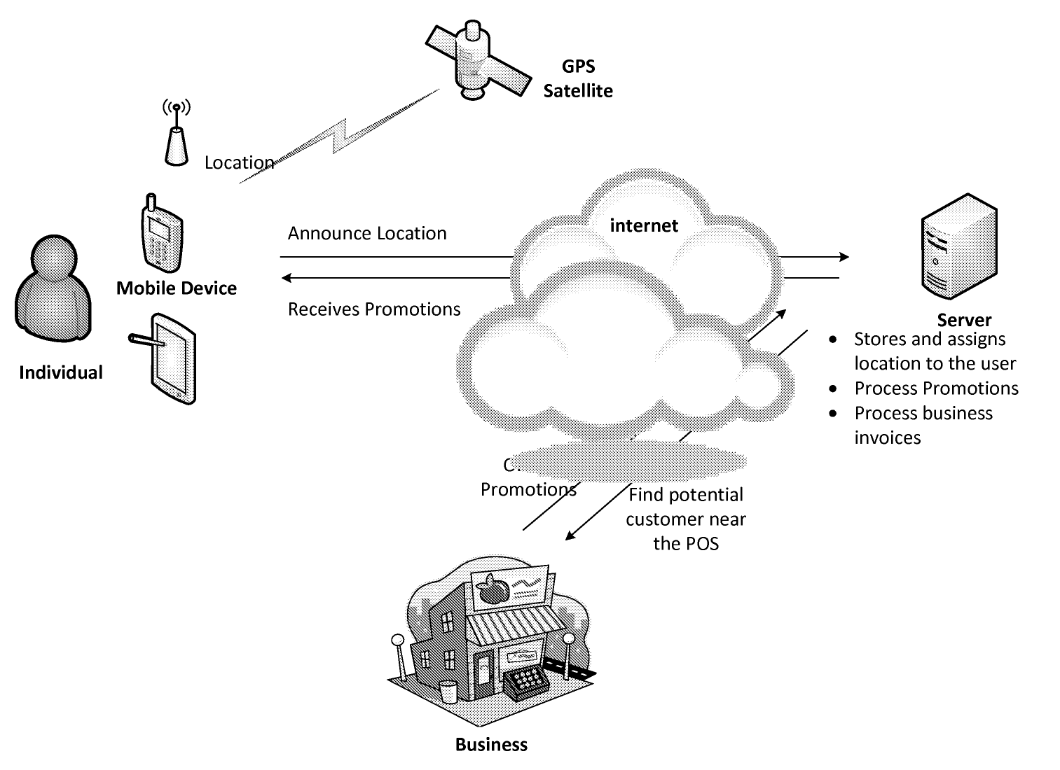

### BRIEF DESCRIPTION OF THE DRAWING

The main components shown in the attached schematic are
Potential customers (Individual) with the mobile device,
Business/advertiser with desktop or mobile device and
Central application (computer program) accessible by both the business/advertiser and the consumers.

Above entity can perform several functions on their own and they also interact with central application to achieve the benefits claimed in this publication. Stand-alone functions are shows in a rectangle box under the entity in the schematic.

Below are the stand alone functions and their descriptions:

Get Location: Individual using a mobile device can determine his/her location.

The mobile device can determine its location using GPS satellites, the network address on the internet (using WiFi) or by using the known location of the cell tower being used.

Store User Location: The central application can store the location of each active user when his/her mobile device reports a location for the user. When the same user's mobile device reports a different location, the central application updates his/her location in its database.

Process Business Communications: The central application is responsible for storing and forwarding business communication to intended recipients. When a vendor/advertisement creates a business communication for nearby individuals, this function stores the message and forwards the message to identified individual's mobile device. Similarly if an individual has created a communication for a business user, this function within the central application will store and forward the message to intended vendor/advertiser. The internet infrastructure acts as a communication link between the sending and receiving entities.

Process Invoicing Information: This is an optional module at the central application. It can keep the account of the number of business messages sent on behalf of Business vendor/advertiser. The owner of the business application can charge the business vendor/advertisers based on number of messages sent successfully to the individual users.

### DESCRIPTION

There are several means by which a business/advertiser can reach its target audience. The common examples of such media outlets are television, newspaper, mailers, magazines, computers, mobile devices, radio, point of sale printed material, etc. The advertiser selects the suitable media outlet based on their target audience and the cost to reach them. Most often, the advertisers will select more than one media outlet to have a broad reach for their message.

There are many business needs where target audience can be anyone who is nearby. To influence such audience many options exist e.g. billboards, printed material, etc. This publication is attempting to show another such avenue where an advertiser can target nearby potential customers who have shown willingness to receive such business announcements.

Many mobile devices such as cellular phone, tablet computers, etc. are capable of determining the device's geographical location at any time, based on Global Position Satellite (GPS), cellular tower or the Wi-Fi network. The claimed benefits are available when the set up as indicated by the enclosed schematic is established with individual actors performing their assigned functions. As shown in the schematic, the main components are the potential customers with the mobile device, advertiser with desktop or mobile device and a central application (computer program) between the advertiser and the consumers.

The central application/computer program (referred to as ‘application’ in this publication) and the mobile device with location-determining function are the key enablers for this application. Following paragraph describes the key features needed from each of these components for the stated benefits to be available:

Application features: The application has following main components. The correct combination of all of them provides the stated benefits.

Server component: It can house all the account holders' information and has processing power to process any computing requirements. The key information for the account holder are: location, activity status (active, idle, logged off, etc.), name, contact information, business announcement detail, message details (time, sender, receiver, etc.), invoicing details etc. The major services that the server component can provide are:
Provide a list of account holders (both business and individual) near a location
Show details such as account holder's status, location, preference, announcement (for business account holder), etc. of an account holder
Process and route the messages sent between two account holders

All of above services results in results which are displayed by the client component.

Client component: This can be enabled on the account holder's computer (desktop or mobile device). It provides usable functionality such as displaying the other account holder near a specific location, allowing the user interface to send and receive messages, providing user interface for creating a new account, signing in/out of the application etc. The location discovery can be displayed in either ‘map view’ (where other account holders are shown on a map of the location) or a ‘list view’ (where other account holders are shown in list sorted by the distance from the specified location).

Mobile device features: The mobile device envisioned in this publication is the one with following key features available with it:

Computing processor: It should have reasonable computing processing capacity to process the workload placed by the account holder's interaction with the application in a timely manner

Location determination: It should be able to determine the device's geographic location when requested by account holder/application

User interface: It should provide a user interface, which allows the account holder to input alphanumeric input, select action out of options provided by the application, and be able to display the screen provided by the application

Internet access: It should provide network access to the remote server through more common TCP/IP or any other means

Enclosed schematic shows the basic configuration for such utility using mobile devise, GPS satellite, internet connection and the computer application.

Before the stated benefits for the consumer and the advertiser can be achieved, there are few preconditions that need to be met by both vendor/advertiser and consumers. Not all preconditions are needed for each benefit. The detail procedure explaining the benefit below clarifies which precondition is needed for a particular benefit:

Pre-Conditions

i. The consumer needs to accompany the mobile device that is used for discovering the location

ii. The consumer needs to have an account with the application to communicate between the vendor and the consumer (such consumers are referred to as accountholder consumers)

iii. The consumer need to activate the application used to communicate between the vendor and the consumer

iv. The consumer need to activate the location determining function on the mobile device

v. The vendor/advertiser needs to claim the location of its establishment

vi. The vendor/advertiser needs to have an account with the application to communicate between the vendor and the consumer

vii. The vendor/advertiser need to activate the application used to communicate between the vendor and the consumer

viii. The vendor/advertiser need to activate the location-determining function on the mobile device

The remaining sections in this publication explain stated benefits and procedures to achieve them.
A. The vendor/advertiser can discover nearby consumers

Precondition must be met: (i, ii, iii, iv, v, vi, vii)

When a vendor/advertiser wants to discover the potential consumers available through this media, he/she can log in to the application and send such request along with its own location to the server component, which in turn can reply with the account holder consumers who are near the location of the business. If the business user is at his/her business location and has location-determining function activated (precondition viii), the accountholder consumers can be discovered by implicitly providing the business location to the application behind the scene by the client component of the application.
B. The vendor/advertiser can publish the business announcement (such as promotion, etc.) so that the consumer can discover the promotion Precondition must be met: (i, ii, iii, v, vi)

The application can allow the business user to announce their promotion or other business messages. This information can be stored along with other discoverable information regarding the vendor/advertiser such as name, type of business, location, etc. on the application server. The potential consumer can log in to the application and send the request querying the business along with its own location to the server component, which in turn can reply with the business details along with the business announcements or promotions.
C. The business user can send one-on-one business message to the consumer Precondition must be met: (i, ii, iii, iv, v, vi)

The application server component along with client component on the mobile device can orchestrate sending and receiving instant message between the registered account holders. Using this functionality the business user can send the business message to an individual accountholder consumer. Such message is sent from the business user's computer device interface to the Application. The Application's server component processes these messages and forwards it to the intended user on the network. Such message can provide details of the message along with the means to claim the benefits in the announcement.
D. The consumer can reach back to the business user for any clarifications, questions, feedback etc. Precondition must be met: (i, ii, iii, iv, v, vi, vii, viii)

The application server component along with client component on the mobile device can orchestrate sending and receiving instant message between the registered account holders.

Using this functionality the potential consumer user can send the message to the business user. Such message is sent from the consumer user's mobile device interface to the Application. The Application's server component processes these messages and forwards it to the intended business user on the network. Such message can include clarifications, questions, feedback on the product and/or services provided by the business user.

1. By using (GPS or other) location determining features and by using other existing technology set up of the cellular services, along with a centrally available computer program:
A. The vendor/advertiser can discover nearby consumers
B. The vendor/advertiser can publish the Business communication (such as promotion) so that the consumer can discover the business announcements (promotion, etc.)
C. The vendor/advertiser can send one-on-one message to the consumer detailing the business announcement (e.g. promotion) and call for action to get the benefit announced
D. The consumer can reach back to the vendor/advertiser for any clarifications, questions, feedback etc. regarding product/promotion
